(19) United States
(12) Patent Application Publication
(10) Pub. No.: US 2026/0103052 A1
(43) Pub. Date: Apr. 16, 2026

(54) VEHICLE EQUIPPED WITH AIR CONDITIONING DEVICE

(71) Applicant: TOYOTA JIDOSHA KABUSHIKI KAISHA, Toyota-shi (JP)

(72) Inventor: Akira TSUCHIYA, Seto-shi (JP)

(73) Assignee: TOYOTA JIDOSHA KABUSHIKI KAISHA, Toyota-shi (JP)

(21) Appl. No.: 19/225,076

(22) Filed: Jun. 2, 2025

(30) Foreign Application Priority Data
Oct. 11, 2024 (JP) 2024-178616

(51) Int. Cl. B60H 1/32; B60H 1/00

(52) U.S. Cl. CPC B60H 1/3228; B60H 1/00021; B60H 2001/00085

(57) ABSTRACT

A vehicle is equipped with an air conditioning device including: a refrigerant circuit configured to circulate a hydrocarbon-based refrigerant; a first cooling liquid circuit including a radiator and configured to circulate a cooling liquid heated by the refrigerant circuit; and a second cooling liquid circuit including a cooler core for cooling an air conditioning airflow and configured to circulate the cooling liquid cooled by the refrigerant circuit. The vehicle includes: an outside air intake device configured to take in air to be used in the radiator from the outside of the vehicle; an outlet port configured to discharge the air taken in by the outside air intake device to the outside of the vehicle; a gas sensor configured to detect the hydrocarbon-based refrigerant outside the refrigerant circuit; and a controller configured to operate the outside air intake device when the hydrocarbon-based refrigerant is detected by the gas sensor.

### CROSS-REFERENCE TO RELATED APPLICATION

This application claims priority to Japanese Patent Application No. 2024-178616 filed on Oct. 11, 2024. The disclosure of the above-identified application, including the specification, drawings, and claims, is incorporated by reference herein in its entirety.

### BACKGROUND

### 1. Technical Field

The present specification relates to vehicles equipped with an air conditioning device. More particularly, the present specification discloses a vehicle equipped with an air conditioning device using a hydrocarbon-based refrigerant.

### 2. Description of Related Art

In recent years, it has been considered to use hydrocarbon-based refrigerants (HC-based refrigerants) such as propane with a low global warming potential as refrigerants for air conditioning devices. Since HC-based refrigerants are flammable, configurations for preventing refrigerant leaks beforehand, configurations for ensuring safety in the event of a refrigerant leak, etc. have been considered.

Japanese Unexamined Patent Application Publication No. 2005-178428 (JP 2005-178428 A) discloses an air conditioning device for a vehicle. In this air conditioning device, a heat exchanger in which a flammable refrigerant flows is disposed in a casing that sends an air conditioning airflow into a vehicle cabin. In this air conditioning device, the amount of flammable refrigerant that has leaked into the casing is detected. When the leak is small, the amount of outside air introduced into the casing is increased. When the leak is large, an air conditioning airflow outlet of the casing and an internal air inlet of the casing are closed to ensure safety.

### SUMMARY

When a vehicle equipped with an air conditioning device using a hydrocarbon-based refrigerant is parked in a closed space such as a garage or an underground parking lot, and the hydrocarbon-based refrigerant leaks from the air conditioning device while the vehicle is parked in the closed space, there is a risk that the hydrocarbon-based refrigerant may accumulate in the closed space. In this case, there is a possibility that a high concentration area where the refrigerant concentration exceeds a predetermined level may form inside the enclosed space.

The present specification discloses a configuration related to a vehicle equipped with an air conditioning device using a hydrocarbon-based refrigerant, specifically a configuration that can reduce formation of an area with a high concentration of the hydrocarbon-based refrigerant inside a closed space while the vehicle is parked in the closed space.

A vehicle equipped with an air conditioning device disclosed in the present specification is a vehicle equipped with an air conditioning device including: a refrigerant circuit including a compressor, a condenser for heat dissipation, an expansion valve, and an evaporator for heat absorption and configured such that a hydrocarbon-based refrigerant circulates in the refrigerant circuit; a first cooling liquid circuit including a radiator and configured such that a cooling liquid heated by the condenser of the refrigerant circuit circulates in the first cooling liquid circuit; and a second cooling liquid circuit including a cooler core configured to cool an air conditioning airflow, the second cooling liquid circuit being configured such that the cooling liquid cooled by the evaporator of the refrigerant circuit circulates in the second cooling liquid circuit. The vehicle includes:
an outside air intake device configured to take in air to be used in the radiator from the outside of the vehicle;
an outlet port configured to discharge the air taken in by the outside air intake device to the outside of the vehicle;
a gas sensor configured to detect the refrigerant outside the refrigerant circuit; and
a controller configured to operate the outside air intake device when the refrigerant is detected by the gas sensor.

With this configuration, when the hydrocarbon-based refrigerant leaks from the refrigerant circuit while the vehicle is parked in a closed space, the refrigerant leak is detected by the gas sensor. When the refrigerant is detected by the gas sensor, the outside air intake device is operated. Therefore, the outside air can be discharged to the outside of the vehicle through the outlet port. The air in the closed space is thus stirred, which reduces formation of an area with a high concentration of the hydrocarbon-based refrigerant in the closed space.

In the vehicle of the present disclosure, the outside air intake device may be disposed forward of the refrigerant circuit so as to supply the air to a region below the refrigerant circuit.

Since hydrocarbon-based refrigerants are generally heavier than air, the refrigerant having leaked from the refrigerant circuit flows downward. In the above configuration, the outside air intake device supplies the air to the region below the refrigerant circuit. This allows the leaked refrigerant to be stirred, which can reduce formation of an area with a high concentration of the refrigerant.

In the vehicle of the present disclosure,
the outside air intake device may be disposed inside an engine compartment of the vehicle, and
the outlet port may be provided in an undercover of the engine compartment at a position rearward of the outside air intake device in the front-rear direction of the vehicle.

With this configuration, the outside air can be discharged to the outside of the vehicle from the bottom of the engine compartment.

In the vehicle of the present disclosure,
the outside air intake device may be disposed inside an engine compartment of the vehicle, and
the outlet port may be provided in a wall of the engine compartment at a position rearward of
the outside air intake device in the front-rear direction of the vehicle. The wall of the engine compartment is a wall defining a wheelhouse.

With this configuration, the outside air can be discharged to the outside of the vehicle from the wall defining the wheelhouse.

The vehicle of the present disclosure may further include an air guide member configured to guide the air taken in by the outside air intake device to the outlet port.

With this configuration, the air taken in by the outside air intake device can be smoothly guided to the outlet port.

In the vehicle of the present disclosure, the hydrocarbon-based refrigerant may be propane or a refrigerant mainly containing propane.

The technique disclosed in the present specification can reduce formation of an area with a high concentration of a hydrocarbon-based refrigerant inside a closed space while a vehicle is parked in the closed space.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of a vehicle equipped with an air conditioning device and a garage;

FIG. 2 is a schematic diagram illustrating a configuration of an air conditioning device;

FIG. 3 is a perspective view illustrating an example of a refrigerant module;

FIG. 4 is a flow chart illustrating control of a radiator fan during parking; and

FIG. 5 is a schematic plan view illustrating a front portion of another vehicle equipped with an air conditioning device.

### DETAILED DESCRIPTION OF EMBODIMENTS

### Introduction

Hereinafter, embodiments will be described with reference to the drawings. In all the drawings, equivalent elements are denoted by the same reference numerals, and redundant description is omitted. In the following description, unless otherwise specified, the terms indicating the front-rear, right-left, and up-down, etc. directions indicate the directions related to a vehicle. In each figure, the direction of the arrow FR indicates a forward direction, the direction of the arrow UP indicates an upward direction, and the direction of the arrow LH indicates a leftward direction.

The air conditioning device is mounted on a vehicle such as an automobile. In the embodiments described below, the type of the vehicle on which the air conditioning device is mounted is not limited. For example, the vehicle may be an engine vehicle using an engine as a power source, or a battery electric vehicle using a motor as a power source. The vehicles may also be a hybrid battery electric vehicle or a plug-in hybrid battery electric vehicle equipped with both an engine and a motor. In addition, the vehicles may be a fuel cell electric vehicle equipped with fuel cells or may be a battery electric vehicle that runs with electric power stored in a battery.

The air conditioning device includes a refrigerant circuit in which a hydrocarbon-based refrigerant (referred to as HC-based refrigerant) circulates. HC-based refrigerants are flammable. Examples of HC-based refrigerants include propane, butane, isobutane, ethane, ethylene, and propylene. In the refrigerant circuit, a refrigerant obtained by mixing one of these HC-based refrigerants or two or more of these HC-based refrigerants may be used. In the refrigerant circuit, a mixed refrigerant mainly containing one or more HC-based refrigerants and further containing a refrigerant other than HC-based refrigerants, various additives, etc. may be used. For example, in the refrigerant circuit, propane or a refrigerant mainly containing propane and further containing at least one of another refrigerant and an additive (refrigerant mainly containing propane) may be used. The HC-based refrigerant may be R290 as an example. In the present specification, the hydrocarbon-based refrigerant means a pure hydrocarbon-based refrigerant or a refrigerant mainly containing a hydrocarbon-based refrigerant.

The refrigerant circuit serves as a heat source of the air conditioning device. The refrigerant circuit includes, in order along the flow direction of the refrigerant, a compressor, a condenser for heat dissipation, an expansion valve, and an evaporator for heat absorption. A receiver may be provided between the condenser and the expansion valve. An accumulator may be provided between the evaporator and the compressor.

The air conditioning device may include a high-temperature cooling liquid circuit in which the cooling liquid heated by the condenser of the refrigerant circuit circulates, and a low-temperature cooling liquid circuit in which the cooling liquid cooled by the evaporator of the refrigerant circuit circulates. The cooling liquid is a heat medium, and the high-temperature cooling liquid circuit and the low-temperature cooling liquid circuit are each a heat medium circuit.

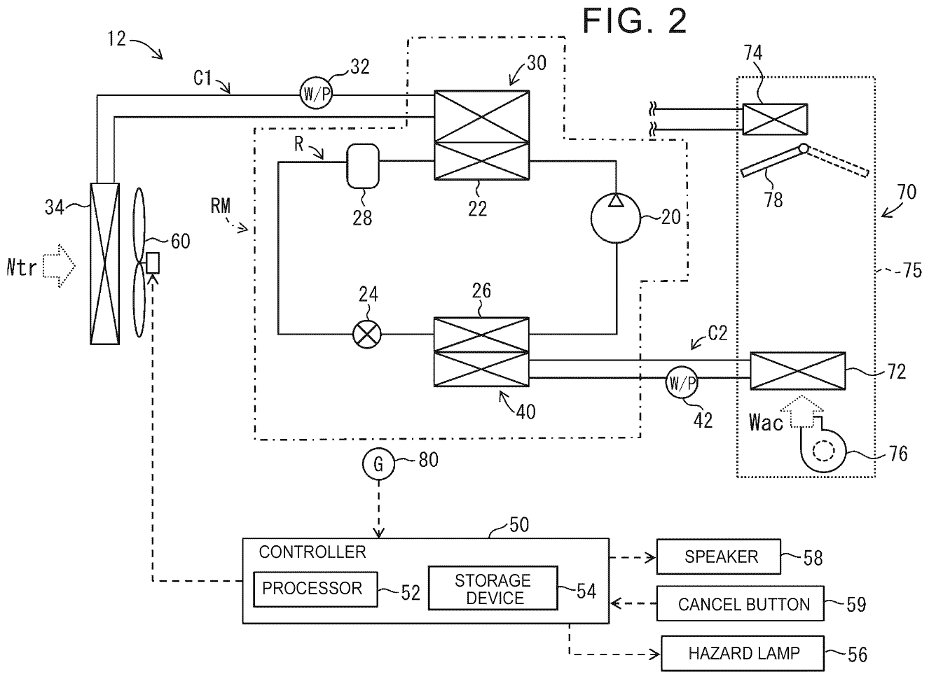

In the embodiment described below, as shown in FIG. 2, the air conditioning device 12 includes a first cooling liquid circuit C1 as a high-temperature cooling liquid circuit and a second cooling liquid circuit C2 as a low-temperature cooling liquid circuit. The cooling liquid of the first and second cooling liquid circuits C1, C2 may be coolant. That is, the cooling liquid may be water containing no additive, water containing an additive such as an antifreeze agent or an antiseptic, or a coolant liquid. The cooling liquid may be a liquid heat medium such as oil, and is not limited thereto.

In the embodiments described below, the refrigerant circuit is located below the front hood of the vehicle. In the following, the area under the front hood is referred to as an “engine compartment” regardless of the presence or absence of a power source (engine, motor, etc.) under the front hood and the type of the power source.

### Embodiments

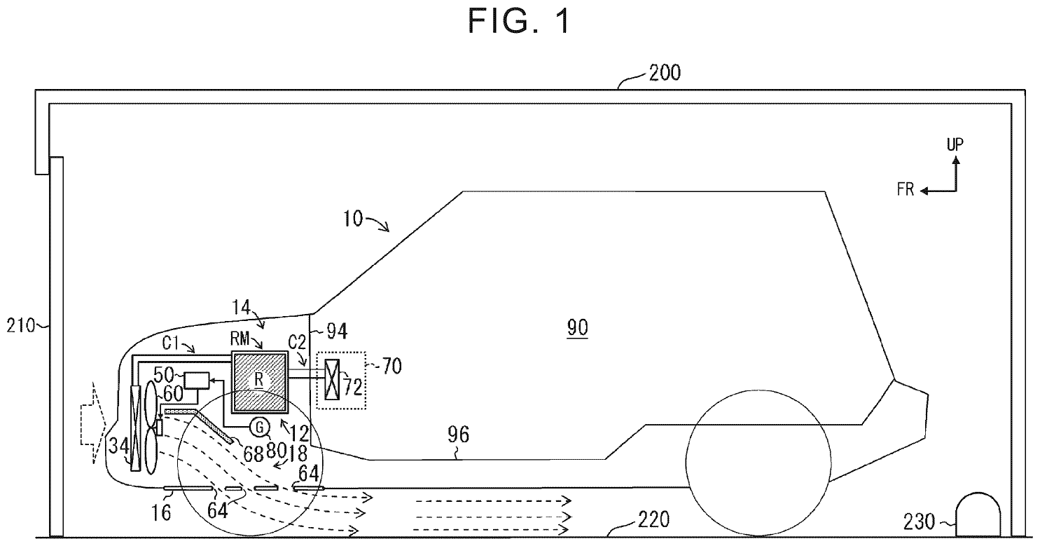

FIG. 1 is a schematic configuration diagram of a vehicle 10 equipped with an air conditioning device and a garage 200 according to an embodiment. The vehicle 10 equipped with an air conditioning device (hereinafter simply referred to as “vehicle”) is parked in a garage 200. A refrigerant circuit R of the air conditioning device 12 and the like are disposed in the engine compartment 14 located in the front portion of the vehicle 10.

FIG. 2 is a schematic diagram illustrating a configuration of the air conditioning device 12. The air conditioning device 12 performs air conditioning of the interior of the vehicle 10. The air conditioning device 12 includes a refrigerant circuit R serving as a heat source, a first cooling liquid circuit C1, a second cooling liquid circuit C2, and an air conditioning unit 70. In the first cooling liquid circuit C1, the first cooling liquid heated by the refrigerant in the refrigerant circuit R circulates. In the second cooling liquid circuit C2, the second cooling liquid cooled by the refrigerant in the refrigerant circuit R circulates. The air conditioning unit 70 supplies the air cooled by the second cooling liquid circulating in the second cooling liquid circuit C2 to the vehicle cabin.

The refrigerant circuit R is a closed circuit in which the compressor 20, the condenser 22, the receiver 28, the expansion valve 24, and the evaporator 26 are sequentially connected by a refrigerant pipe (refrigerant channel), and the hydrocarbon-based refrigerant (hereinafter, also simply referred to as refrigerant) is circulated.

The air conditioning device 12 includes a heat exchanger 30. The heat exchanger 30 is integrated with the condenser 22 of the refrigerant circuit R, and exchanges heat between the refrigerant of the refrigerant circuit R and the first cooling liquid of the first cooling liquid circuit C1. The heat exchanger 30 is a water-cooled condenser. The heat exchanger 30 may be, for example, a plate heat exchanger.

The first cooling liquid circuit C1 is a closed circuit in which the water pump 32, the heat exchanger 30, and the radiator 34 are sequentially connected by cooling liquid pipes to circulate the first cooling liquid. The radiator 34 is a heat exchanger that exchanges heat between the first cooling liquid and the vehicle traveling wind Wtr. In the first cooling liquid circuit C1, the first cooling liquid pumped by the water pump 32 is heated to a high temperature by the heat dissipation of the refrigerant in the condenser 22 in the refrigerant circuit R while passing through the heat exchanger 30. The high-temperature first cooling liquid is sent to the radiator 34, where it is cooled by the vehicle traveling wind Wtr.

The air conditioning device 12 includes a radiator fan 60 as an outside air intake device. The radiator fan 60 is disposed behind the radiator 34, and takes in air into the engine compartment from the outside of the vehicle. The radiator fan 60 cools the first cooling liquid in the radiator 34 by passing outside air from the front to the rear of the radiator 34.

Further, the air conditioning device 12 includes a heat exchanger 40. The heat exchanger 40 is integrated with the evaporator 26 of the refrigerant circuit R, and exchanges heat between the refrigerant of the refrigerant circuit R and the second cooling liquid of the second cooling liquid circuit C2. The heat exchanger 40 may be, for example, a plate heat exchanger.

The second cooling liquid circuit C2 is a closed circuit in which the water pump 42, the heat exchanger 40, and the cooler core 72 are sequentially connected by cooling liquid pipes to circulate the second cooling liquid. The cooler core 72 is a heat exchanger that is disposed in the air passage 75 of the air conditioning unit 70 and exchanges heat between the second cooling liquid and the air conditioning airflow Wac. In the second cooling liquid circuit C2, the second cooling liquid pumped by the water pump 42 becomes a low temperature due to the heat absorption of the refrigerant in the evaporator 26 in the refrigerant circuit R while passing through the heat exchanger 40. The second cooling liquid having reached the low temperature is sent to the cooler core 72, where it cools the air conditioning airflow Wac.

In the refrigerant circuit R, the refrigerant circulates as follows. Compressor 20 discharges a high-pressure gas refrigerant, the gas refrigerant is liquefied condensed by heat exchange with the first cooling liquid of the first cooling liquid circuit C1 passing through the heat exchanger 30 in the condenser 22, and becomes a high-pressure liquid refrigerant. The high-pressure liquid refrigerant flowing out of the condenser 22 is decompressed and expanded by the expansion valve 24 via the receiver 28, becomes a low-pressure refrigerant, and flows into the evaporator 26. The low-pressure refrigerant flowing into the evaporator 26 is evaporated by heat exchange with the second cooling liquid in the second cooling liquid circuit C2 passing through the heat exchanger 40 in the evaporator 26, becomes a gaseous refrigerant, flows out the evaporator 26, and returns to the compressor 20.

The air conditioning unit 70 includes a blower 76 and an air passage 75 formed by a case (not shown). In the air passage 75, a blower 76, a cooler core 72, and a heater core 74 are arranged in this order from the air flow direction. The heater core 74 is, for example, a heat exchanger to which engine coolant or coolant warmed by a water-heating PTC heater is supplied. The heater core 74 may be configured to supply the cooling liquid warmed by the heat exchanger 30.

The blower 76 introduces air into the air passage 75 from an intake port (not shown) and allows the air to be passed through the cooler core 72 and the heater core 74, thereby blowing the temperature-controlled air into the vehicle cabin. An air mix door 78 is provided inside the air passage 75, and the air mix door 78 adjusts a ratio at which the air that has passed through the cooler core 72 flows to the heater core 74. Note that the air conditioning unit 70 may employ a conventional technique of HVAC (Heating, Ventilation, and Air Conditioning).

The air conditioning device 12 includes a gas sensor 80, a controller 50, a speaker 58, and a release button 59. The gas sensor 80 detects the refrigerant outside the refrigerant circuit R. For example, the gas sensor 80 detects a refrigerant with a predetermined concentration or more leaked from the refrigerant circuit R.

The controller 50 may be configured to include a microcomputer, and may be, for example, an ECU (Electronic Control Unit). The controller 50 includes a processor 52 and a storage device 54. The processor 52 includes a CPU (Central Processing Unit), and CPU operates in accordance with programs and control data stored in the storage device 54 to execute various operations and controls. The storage device 54 may include a ROM (Read Only Memory), a RAM (Random Access Memory), flash memory, and the like.

The controller 50 receives a detection signal of the gas sensor 80 and an operation signal indicating whether or not the release button 59 is operated. The controller 50 controls the radiator fan 60 and the speaker 58. Further, the vehicle 10 includes a hazard lamp 56 (emergency blinking indicator lamp). The controller 50 may control the hazard lamp 56 directly or via other controllers.

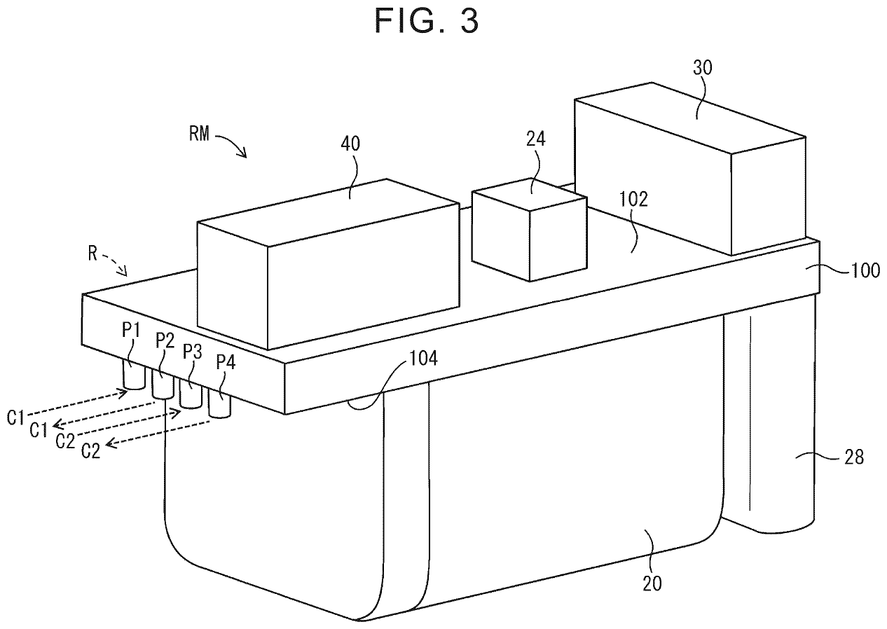

FIG. 3 is a perspective view illustrating an example of a refrigerant module RM. The refrigerant circuit R is integrated to form a refrigerant module RM. Specifically, the refrigerant module RM is a unit of the air conditioning device 12 in which a device and a channel inside the long dashed short dashed line in FIG. 2 are integrated.

As shown in FIG. 3, the refrigerant module RM comprises a plate 100. The plate 100 is a fixed member to which a plurality of devices is fixed. The plate 100 has a rectangular shape in a top view and has a constant thickness. The plate 100 may be made of, for example, aluminum. The heat exchanger 30, the expansion valve 24, and the heat exchanger 40 are fixed to the upper surface 102 of the plate 100. The compressor 20 and the receiver 28 are fixed to the lower surface 104 of the plate 100.

A channel (not shown) is provided in the plate 100 in the form of a tunnel. Specifically, inside the plate 100, a refrigerant channel of the refrigerant circuit R, a cooling liquid channel of part of the first cooling liquid circuit C1 (channel of the first cooling liquid that communicates with the heat exchanger 30), and a cooling liquid channel of part of the second cooling liquid circuit C2 (a channel of the second cooling liquid that communicates with the heat exchanger 40) are provided. Note that the refrigerant module RM may include a pipe or a component for at least one of the refrigerant channel and the cooling liquid channel on the outer side of the plate 100 in addition to or instead of the channel inside the plate 100.

As shown in FIG. 3, the refrigerant module RM includes ports P1 to P4. The ports P1 to P4 are provided on the lower surface of the end portion of the plate 100 on one side in the longitudinal direction. The ports P1, P2 communicate with the channel of the first cooling liquid inside the plate 100, and the piping of the first cooling liquid circuit C1 is connected. The ports P3, P4 communicate with the channel of the second cooling liquid inside the plate 100, and the piping of the second cooling liquid circuit C2 is connected.

As shown in FIG. 1, the refrigerant module RM is disposed in the engine compartment 14. The gas sensor 80 is located in the engine compartment 14 and below the refrigerant module RM. The engine compartment 14 and the vehicle cabin 90 are partitioned by a dashboard 94. An instrument panel (not shown) is provided on the vehicle cabin 90 side of the dashboard 94. The air conditioning unit 70 is disposed between the instrument panel and the dashboard 94. A floor panel 96 forming a floor of the vehicle cabin 90 is connected to a lower end portion of the dashboard 94.

The first cooling liquid circuit C1 is located in the engine compartment 14 and is located in front of the refrigerant module RM. The radiator 34 is disposed in a front end region in the engine compartment 14. The radiator fan 60 is disposed immediately behind the radiator 34. The radiator fan 60 is disposed in front of the refrigerant circuit R so as to supply air to the area 18 below the refrigerant circuit R (the refrigerant module RM).

The vehicle 10 includes an undercover 16 that is at least a part of a bottom wall of the engine compartment 14. The undercover has one or more outlet ports 64. The outlet port 64 is located rearward of the radiator fan 60. The outlet port 64 may be provided below the refrigerant circuit R.

Further, the vehicle 10 includes an air guide plate 68 that guides the air drawn in by the radiator fan 60 to the outlet port 64. The air guide plate 68 is an example of an air guide member. The air guide plate 68 is disposed in the engine compartment 14 rearward of the radiator fan 60. The air guide plate 68 has an inclined portion that is inclined downward from the front toward the rear. The air taken in by the radiator fan 60 is directed downward by the inclined portion of the air guide plate 68 as indicated by a dashed line (air flow) in FIG. 1, and is guided to the outlet port 64 of the undercover 16. The air guide plate 68, as shown in FIG. 1, so as not to hinder the detection of the refrigerant by the gas sensor 80, i.e., so that air is not blown to the detection region of the gas sensor 80, it is preferable to direct the air.

The vehicle 10 is parked in the garage 200. The garage 200 forms an enclosed space dedicated to the vehicle. A garage door 210 for entering and leaving the vehicle 10 is provided at a front portion of the garage 200. A discharge opening 230 is provided in the side wall of the rear lower portion of the garage 200. The discharge opening 230 is an opening for discharging air in the garage 200 to the outside of the garage 200.

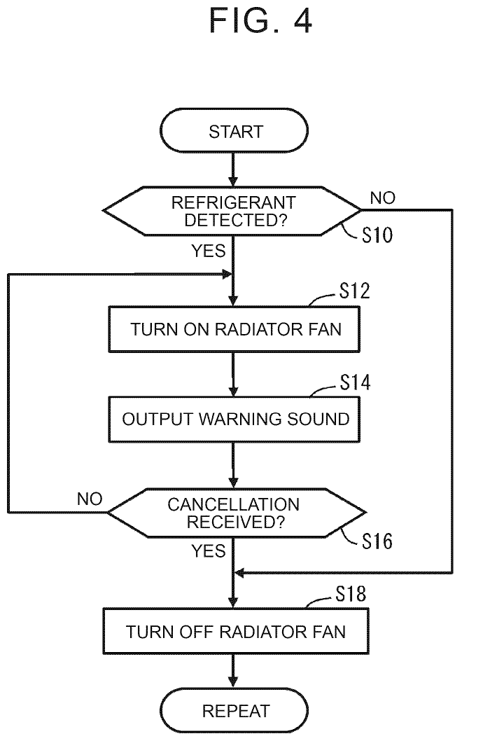

FIG. 4 is a flowchart showing control of the radiator fan 60 at the time of parking of the vehicle 10. The control illustrated in FIG. 4 is repeatedly executed in a predetermined cycle.

In S10, the controller 50 checks whether the refrigerant has been detected by the gas sensor 80. When the refrigerant is not detected by the gas sensor 80 (S10: No), the controller 50 does not operate the radiator fan 60 (S18).

On the other hand, when the refrigerant is detected by the gas sensor 80 (S10: Yes), the controller 50 operates the radiator fan 60 (S12). In addition, the controller 50 outputs an alarm sound from the speaker 58 (S14). The controller 50 may turn on the hazard lamp 56 of the vehicle 10 in addition to or instead of the output of the alarm sound.

In S16, the controller 50 checks whether the release button 59 has been pressed by the user (or a serviceman, hereinafter the same). When the release button 59 is not pressed (S16: No), the controller 50 continues the operation (S12) of the radiator fan 60 and the output (S14) of the alarm sound.

On the other hand, when the release button 59 is pressed by the user (S16: Yes), the controller 50 stops the operation of the radiator fan 60 (S18). At this time, the controller 50 also stops the output of the alarm sound from the speaker 58. When the hazard lamp 56 is turned on in S14, the controller 50 turns off the hazard lamp 56.

In this embodiment, when the release button 59 is pressed, the operation of the radiator fan 60 is stopped, but the controller 50 may continue the operation of the radiator fan 60 while the refrigerant is detected by the gas sensor 80.

According to the embodiment described above, as shown in FIG. 1, when the vehicle 10 is parked in the garage 200 as an example of the closed space, when there is a leakage of the hydrocarbon-based refrigerant from the refrigerant circuit R, it is possible to detect the refrigerant leakage by the gas sensor 80. When the refrigerant is detected by the gas sensor 80, the radiator fan 60 is operated to introduce outside air into the engine compartment 14, and the outside air can be discharged from the outlet port 64 to the outside of the vehicle.

As a result, as indicated by the dashed arrows in FIG. 1, the air below the vehicle flows toward the rear of the vehicle, and the air on the floor 220 in the garage 200 can be agitated. Since the hydrocarbon-based refrigerant is generally heavier than air, the refrigerant leaked from the refrigerant circuit R flows downward and is likely to accumulate on the floor 220 of the garage 200. According to the embodiment described above, since the air containing the hydrocarbon-based refrigerant on the floor 220 can be stirred, it is possible to reduce formation of an area with a high concentration of the hydrocarbon-based refrigerant. The hydrocarbon-based refrigerant can be diluted so that the refrigerant concentration does not reach the combustion lower limit.

Further, according to the embodiment described above, since the radiator fan 60 supplies air to the area 18 below the refrigerant circuit R, that is, the area 18 where the refrigerant having leaked from the refrigerant circuit R flows, it is possible to stir the refrigerant. Further, since the outlet port 64 is provided in the undercover 16 of the engine compartment 14, it is possible to discharge the outside air from the bottom of the engine compartment 14 to the outside of the vehicle. Further, since the air guide plate 68 is provided, the air taken in by the radiator fan 60 can be smoothly guided to the outlet port 64.

Further, according to the embodiment described above, since the discharge opening 230 is provided in the garage 200, the leaked refrigerant can be discharged from the discharge opening 230 to the outside of the garage 200.

### Other Embodiments

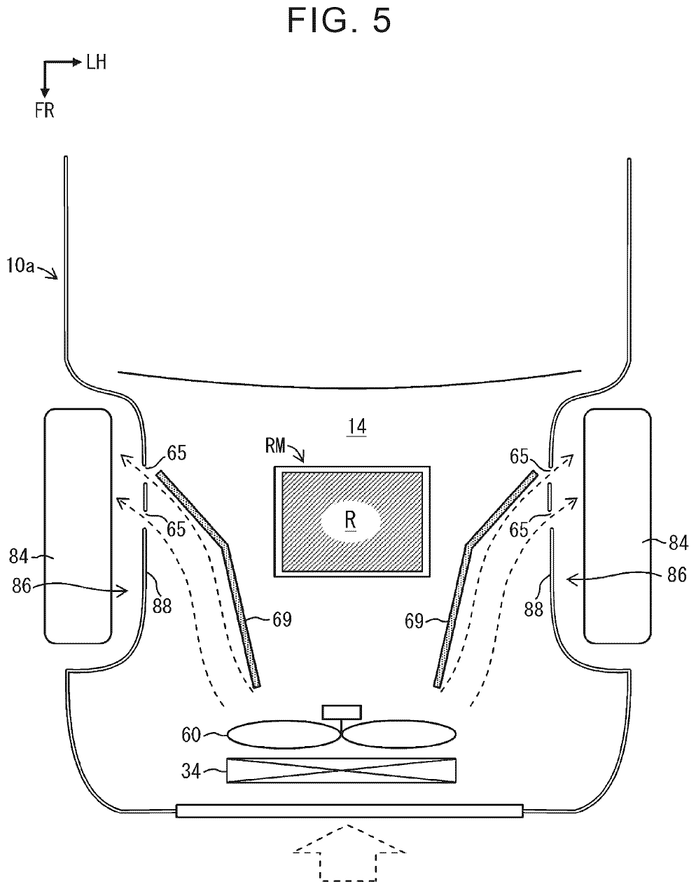

FIG. 5 is a schematic plan view illustrating a front portion of another vehicle 10a equipped with an air conditioning device. In the vehicle 10a, the outlet port 65 and the air guide plate 69 are changed with respect to the vehicle 10 described above. In the vehicle 10a of FIG. 5, one or more outlet ports 65 are provided in the wall 88 of the engine compartment 14 that defines the wheelhouse 86 at a position rearward of the radiator fan 60. The wheelhouse 86 is a space between the tire 84 and the body. The vehicle structure shown in FIG. 5 has a symmetrical shape. The one or more outlet ports 65 are provided in each of the walls 88 of the right and left wheelhouses 86.

The air guide plate 69 is provided on each of the rear right side and the rear left side of the radiator fan 60. The two air guide plates 69 are air guide members that guide the air taken in by the radiator fan 60 to the outlet ports 65 on both the right and left sides.

Also in this vehicle 10a, when a refrigerant leak is detected by the gas sensor, the radiator fan 60 is operated to introduce the outside air into the engine compartment 14, and the outside air can be discharged to the outside of the vehicle through the outlet port 65 of the wall 88 of the wheelhouse 86. As a result, a flow can be generated in the air below the vehicle, and the air in the closed space can be agitated. Therefore, it is possible to reduce formation of an area with a high concentration of the hydrocarbon-based refrigerant.

In the above embodiment, the radiator fan 60 is used for the radiator 34 of the air conditioning device 12. The radiator fan 60 may be used as another radiator in place of or in addition to the radiator 34 of the air conditioning device 12. The outside air intake device is not limited to the radiator fan 60 and may be any device capable of flowing air toward the outlet port. In addition, the outlet port may be an opening that communicates with the engine compartment 14 and the outside of the vehicle, for example, and the position where the outlet port is provided is not limited.

What is claimed is:

1. A vehicle equipped with an air conditioning device, the air conditioning device including: a refrigerant circuit including a compressor, a condenser for heat dissipation, an expansion valve, and an evaporator for heat absorption and configured such that a hydrocarbon-based refrigerant circulates in the refrigerant circuit; a first cooling liquid circuit including a radiator and configured such that a cooling liquid heated by the condenser of the refrigerant circuit circulates in the first cooling liquid circuit; and a second cooling liquid circuit including a cooler core configured to cool an air conditioning airflow, the second cooling liquid circuit being configured such that the cooling liquid cooled by the evaporator of the refrigerant circuit circulates in the second cooling liquid circuit, the vehicle comprising:
an outside air intake device configured to take in air to be used in the radiator from outside of the vehicle;
an outlet port configured to discharge the air taken in by the outside air intake device to the outside of the vehicle;
a gas sensor configured to detect the refrigerant outside the refrigerant circuit; and
a controller configured to operate the outside air intake device when the refrigerant is detected by the gas sensor.

2. The vehicle according to claim 1, wherein the outside air intake device is disposed forward of the refrigerant circuit so as to supply the air to a region below the refrigerant circuit.

3. The vehicle according to claim 1, wherein:
the outside air intake device is disposed inside an engine compartment of the vehicle; and
the outlet port is provided in an undercover of the engine compartment at a position rearward of the outside air intake device in a front-rear direction of the vehicle.

4. The vehicle according to claim 1, wherein:
the outside air intake device is disposed inside an engine compartment of the vehicle; and
the outlet port is provided in a wall of the engine compartment at a position rearward of the outside air intake device in a front-rear direction of the vehicle, the wall being a wall defining a wheelhouse.

5. The vehicle according to claim 1, further comprising an air guide member configured to guide the air taken in by the outside air intake device to the outlet port.
